(19) United States
(12) Patent Application Publication
(10) Pub. No.: US 2017/0354975 A1
(43) Pub. Date: Dec. 14, 2017

(54) Easy-Air - Negative Ion Generator

(71) Applicant: Gal Joe Nahum, Clearwater, FL (US)

(72) Inventor: Gal Joe Nahum, Clearwater, FL (US)

(21) Appl. No.: 15/178,523

(22) Filed: Jun. 9, 2016

(51) Int. Cl. B03C 3/02; B03C 1/02; B03C 3/08

(52) U.S. Cl. CPC B03C 3/025; B03C 3/08; B03C 1/02

(57) ABSTRACT

Easy-Air (-) Ion Generator: The present invention provides an electric device that creates ‘corona discharge’ for cleaning the air from airborne/atmospheric particulate matter including gaseous and biological contaminates. The invention uses high voltage DC current that performs two functions/phases: (1) The first function has two pairs of positive and negative polarity, therein for building a force field between the metal plates for attracting airborne particles, gaseous and biological contaminates that are incinerated. SEE FIG. #1. (2) The second function has negative current wires that goes across the force field, which comes into contact with the filtered air separating negative ions that flow into the room or local area. SEE FIG. #2. The negative ions attach themselves to any particulate matter including soot, tobacco smoke, smog, oil smoke, fly ash, cement dust, suspended atmospheric dust, settling dust, and heavy dust and with its increased molecular weight and pulls the particulate matter to the ground or surface reducing/related atmospheric particulate matter to enhance air quality. Any related airborne/atmospheric particles with a heavier molecular weight due to the negative ionization process are also attracted to the positive current force field and are re-filtered to enhance air quality. SEE FIG. #1. Additionally, the corona discharge is used to split the diatomic oxygen molecule into valent oxygen atoms. These oxygen atoms have a negative charge and will bond quickly with another oxygen molecule to produce ozone. For each split oxygen molecule 2 ozone molecules are produced. SEE FIG. #2.

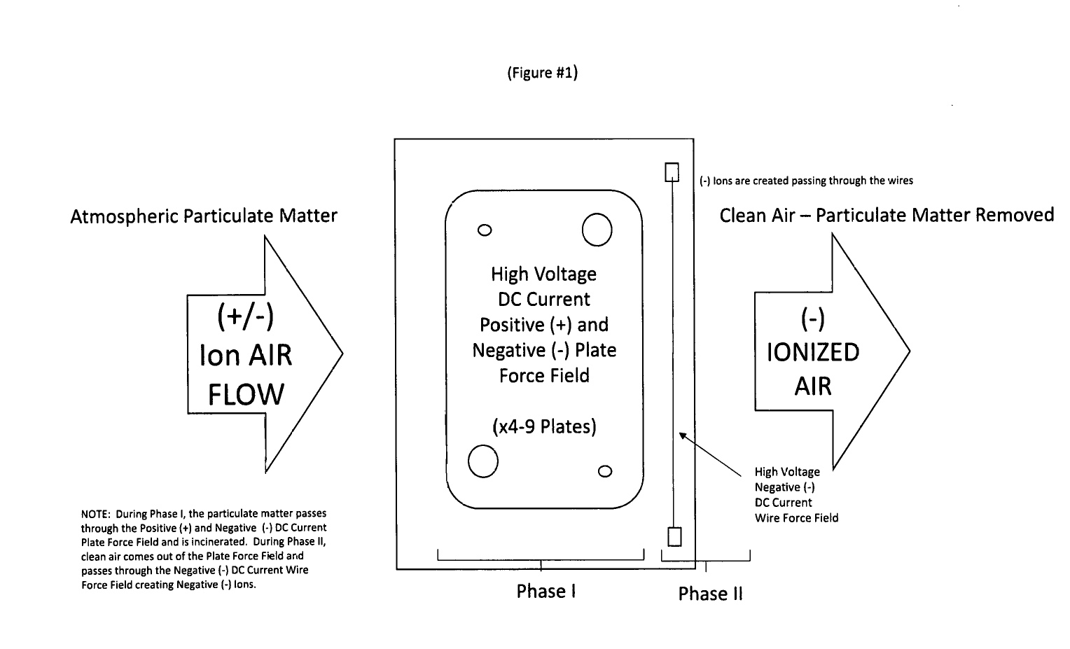

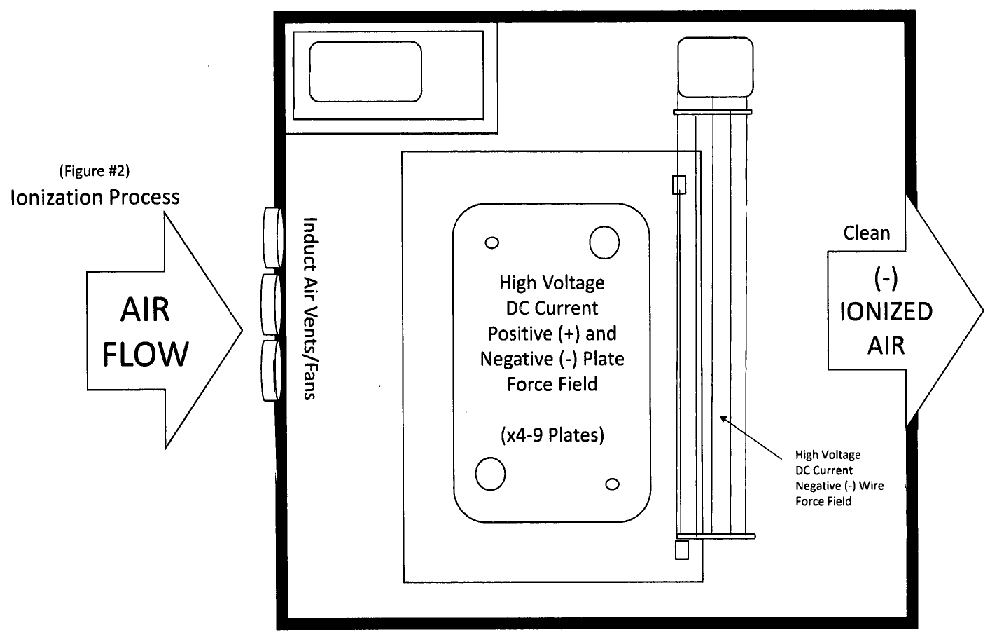

### DESCRIPTION OF THE PRIOR ART

There is no other machine in the market that clean the air on A.C/D.C current

### SUMMARY OF THE INVENTION

The device has two main components; each complements the other by cleaning and ionizing the air passing through it. The air is forced through plates and the wires by a build in fan. 3.6 KVDC transformer supplies 20 mlA of current to two sets of plates, after passing via diodes (their function is to flip the sine, creating “straight” current). Each set is charged opposing static charge. The passing particle is charged in negative or positive charge which causes it to attract and attach itself to the plate with opposing charge. This invention assumes that most of the dirt floating in the air will eventually be attached to the plates thus the air will be clean. The same air continue being forced forth via Ionizer, and will carry Ions into the space. The Ionizer is the second component of this device. Copper wires are connected to a negative leg of the current supply.

### BACKGROUND OF THE INVENTION

This invention extracts dust particles from the air and releases Ions. The size of the room or any space (even in an open field) is directly linked to a physical size of the device. The bigger the area to be clean will result in larger device. The extraction is executed by a means of charging the passing particles with static charge (negative or positive) generated by current in the plates. When the particle has positive charge it is then attracted to the positively charged plate and vise versa. The negative portion of the current passes through copper wires, releasing Ions to the area, by forced air.

1. The Electronic Air Filter device cleans the air by magnetic field generated between opposing charged plates.

2. by releasing -Ions into the space by “Townsend discharge” technique

3. The methode of claim 1, 36 KV DC current is transfer via aluminum plats, creating magnetic field through which the air is forced.
The magnetic field is created between half of the plates being charged in opposing charge to the other half.
The passing air is being disposed off the dust particls by means of magnetic field, which attracts them.

4. The method of claim 2, copper wires.
